(19) United States
(12) Patent Application Publication
(10) Pub. No.: US 2026/0058696 A1
(43) Pub. Date: Feb. 26, 2026

(54) SYSTEM AND METHOD FOR SIMPLIFYING THE PRACH/SRS C-PLANE IN FRONTHAUL INTERFACE

(71) Applicant: Mavenir US Inc., Richardson, TX (US)

(72) Inventor: YangChun Xu, Hangzhou (CN)

(73) Assignee: Mavenir US Inc., Richardson, TX (US)

(21) Appl. No.: 19/378,675

(22) Filed: Nov. 4, 2025

Related U.S. Application Data
(63) Continuation of application No. PCT/CN2023/092012, filed on May 4, 2023.

(51) Int. Cl. H04B 7/0413; H04L 5/00; H04W 88/08

(52) U.S. Cl. CPC H04B 7/0413; H04L 5/005; H04W 88/085

(57) ABSTRACT

There are provided systems, methods, and interfaces for optimization of the fronthaul interface bandwidth for Radio Access Networks and Cloud Radio Access Networks to reduce the traffic the between the baseband unit and the radio unit and then reduce the time needed in DU.

### CROSS REFERENCE TO RELATED APPLICATIONS

This application is a national stage U.S. patent application of International Application No. PCT/CN2023/092012, filed on May 4, 2023, the entirety of which is incorporated herein by reference.

### BACKGROUND OF THE DISCLOSURE

### Field of the Disclosure

The present disclosure relates to systems and methods for radio access networks, including 4G and 5G based mobile networks.

### Description of the Related Art

Open-Radio Access Network (O-RAN) Alliance is a group that defines the specification for the next generation RAN solutions comprising of the interface between the various RAN components such as O-RAN DU, O-RAN CU, and O-RAN RU based on lower layer split (LLS).

FIG. 1 shows an example of a CRAN system architecture 100 and a functional fronthaul split 101 for a BS including cloud RAN 100 with a Central Unit (“CU”) 102 including BBU or BBU pools 103 and one or more Distributed Units (“DU”) 104 including an RU. The BBU pools 103 can be connected to other BBU pools and connected to the evolved packet core (EPC) network 106 via an S1 interface. The RRUs 105 connect User Equipment (UE) 107 to the network.

In order for the RRU 105 to operate and access the unlicensed/shared spectrum, various embodiments of modules can be incorporated in the CRAN and configured for functions such as carrier-selection, Listen-Before-Talk (LBT), dynamic frequency selection (DFS), reference signals transmission (e.g., Discovery reference signal or DRS), and the like.

In conventional LTE networks, the LTE functionalities and the layers of the LTE protocol stack reside in the eNB small cell, which is deployed on site. There are multiple benefits of the CRAN solution (i.e., splitting the BBU 103 and the RRU) compared to traditional LTE networks:

Cloud RAN provides flexibility to the Mobile network operators (“MNO”) to be able to optimize system performance in real-time by varying various configuration and system parameters using the cloud-based infrastructure.

To enable the CRAN solution, the BS LTE functionalities need to be split between the BBU 103 in the cloud and the RU 105 onsite. 3GPP has defined 8 options in TR 38.801 V14.0.0 (2017-03) for the split between the BBU 103 and the RU 105.

Virtualized RAN (vRAN) and Cloud RAN refers to an implementation of the RAN which virtualizes network functions in software platforms based on general purpose processors and moving some of the components to a cloud server.

Conventional RANs were built employing an integrated unit where the entire RAN was processed. Conventional RANs implement the protocol stack (e.g., Physical Layer (PHY), Media Access Control (MAC), Radio Link Control (RLC), Packet Data Convergence Control (PDCP) layers) at the base station (also referred to as the evolved node B (eNodeB or eNB) for 4G LTE or next generation node B (gNodeB or gNB) for 5G NR). In addition, conventional RANs use application specific hardware for processing, which make the conventional RANs difficult to upgrade and evolve.

Cloud-based Radio Access Networks (CRANs) are networks where a significant portion of the RAN layer processing is performed at a baseband unit (BBU), located in the cloud on commercial off the shelf servers, while the radio frequency (RF) and real-time critical functions can be processed in the remote radio unit (RRU), also referred to as the radio unit (RU). Both CUs and DUs are also known as baseband units (BBUs). The BBU can be split into two parts: centralized unit (CU) and distributed unit (DU). CUs are usually located in the cloud on commercial off the shelf servers, while DUs can be distributed. The BBU may also be virtualized, in which case it is also known as vBBU. Radio Frequency (RF) interface and real-time critical functions can be processed in the remote radio unit (RRU).

For the RRU and DU to communicate, an interface called the fronthaul is provided. 3rd Generation Partnership Project (3GPP) has defined 8 options for the split between the BBU and the RRU among different layers of the protocol stack. There are multiple factors affecting the selection of the fronthaul split option such as bandwidth, latency, implementation cost, virtualization benefits, complexity of the fronthaul interface, expansion flexibility, computing power, and memory requirement.

One of the most common splits that are standardized by the O-RAN alliance is split option 7-2× (Intra-PHY split). This split has multiple advantages such as simplicity, transport bandwidth scalability, beamforming support, interoperability, support for advanced receivers and inter-cell coordination, lower O-RU complexity, future proof-ness, interface and functions symmetry.

The fronthaul includes an extended Antenna-Carrier (eAxC) for a message source and destination identifiers. The eAxC comprises a O-DU port identifier (DU_Port_ID), a Band Sector Identifier (BandSector_ID), a Component Carrier Identifier (CC_ID) and an RU Port Identifier (RU_Port_ID). A MIMO spatial stream or MIMO layer is identified based on the RU Port ID.

In a massive MIMO case, RU is usually a 32TRX or 64TRX.

According to the O-RAN CUS specifications as of the present disclosure DU needs to send a C-Plane for each TRX, which places high computational costs on DU and RU.

TABLE 1

| | | | Frame | Subframe | Slot | Sequence | |
|---|---|---|---|---|---|---|---|
| No. | Data Dire | c_eAxC_3D | ID | ID | ID | ID | Info |
| 1579 | Upl . . . | 0:00:4:0 | 35 | 6 | 1 | 147 | C-Plane, Type: 1 (Most channels), Id: |
| 1580 | Upl . . . | 0:00:4:1 | 35 | 6 | 1 | 147 | C-Plane, Type: 1 (Most channels), Id: |
| 1581 | Upl . . . | 0:00:4:2 | 35 | 6 | 1 | 71 | C-Plane, Type: 1 (Most channels), Id: |
| 1582 | Upl . . . | 0:00:4:3 | 35 | 6 | 1 | 71 | C-Plane, Type: 1 (Most channels), Id: |
| 1583 | Upl . . . | 0:00:4:4 | 35 | 6 | 1 | 71 | C-Plane, Type: 1 (Most channels), Id: |
| 1584 | Upl . . . | 0:00:4:5 | 35 | 6 | 1 | 71 | C-Plane, Type: 1 (Most channels), Id: |
| 1585 | Upl . . . | 0:00:4:6 | 35 | 6 | 1 | 71 | C-Plane, Type: 1 (Most channels), Id: |
| 1586 | Upl . . . | 0:00:4:7 | 35 | 6 | 1 | 71 | C-Plane, Type: 1 (Most channels), Id: |
| 1587 | Upl . . . | 0:00:4:8 | 35 | 6 | 1 | 71 | C-Plane, Type: 1 (Most channels), Id: |
| 1588 | Upl . . . | 0:00:4:9 | 35 | 6 | 1 | 71 | C-Plane, Type: 1 (Most channels), Id: |
| 1589 | Upl . . . | 0:00:4:a | 35 | 6 | 1 | 71 | C-Plane, Type: 1 (Most channels), Id: |
| 1590 | Upl . . . | 0:00:4:b | 35 | 6 | 1 | 71 | C-Plane, Type: 1 (Most channels), Id: |
| 1591 | Upl . . . | 0:00:4:c | 35 | 6 | 1 | 71 | C-Plane, Type: 1 (Most channels), Id: |
| 1592 | Upl . . . | 0:00:4:d | 35 | 6 | 1 | 71 | C-Plane, Type: 1 (Most channels), Id: |
| 1593 | Upl . . . | 0:00:4:e | 35 | 6 | 1 | 71 | C-Plane. Tvoe: 1 (Most channels), Id: |

As shown in FIG. 2 and Table 1 each ANT needs 1 C-Plane message. As also shown in in FIG. 2 and Table 1, the content of each message is the same except for the eAxC id.

Traditionally, the radio access networks were built as an integrated unit where the entire RAN was processed. The RAN network traditionally uses application specific hardware for processing, making it difficult to upgrade and evolve. As future networks evolve to have massive densification of networks to support increased capacity requirements, there is a growing need to reduce the capital expense costs and operating expense costs of RAN deployment and make the solution scalable and easy to upgrade.

### SUMMARY

Embodiments of systems and methods to which the present disclosure is directed include the following.

In an implementation, a cloud radio access network (CRAN) system, comprises: a baseband unit (BBU) having a centralized unit (CU) and a distributed unit (DU); and a radio unit (RU) remote from the BBU and comprising a plurality of antenna ports; a fronthaul interface between the RU and the BBU; the DU and RU being configured to agree on an antenna offset for a sounding reference signal (SRS), wherein the DU and RU agree to send a C-Plane message for only a first antenna of the plurality of RU antenna ports, and the RU being configured to send antenna data for the plurality RU antenna ports on receipt of the C-Plane message. The antenna data from the RU can comprise sequence IDs for the U-Plane. The antenna data from the RU can comprise Physical Resource Block (PRB) ranges.

The antenna data from the RU can comprise sequence IDs for the U-Plane. The antenna data from the RU can comprise Physical Resource Block (PRB) ranges. The RU is configured to transmit alternating PRB block ranges following the C-Plane message. The RU can be configured to transmit alternating type identifiers following the C-Plane message. The RU can be configured to transmit alternating PRB block ranges following the C-Plane message. The C-Plane message can include an extended Antenna-Carrier (eAxC) identifier. The Message content for the C-Plane message can comprise fields including: a Message type, a Sequence ID for a sequence number of the C-plane message or the U-Plane message, a Data Direction, a Frame Id, a Subframe Id, and a Slot Id.

In an implementation, a cloud radio access network (CRAN) system, comprises: a baseband unit (BBU) having a centralized unit (CU) and a distributed unit (DU); and a radio unit (RU) remote from the BBU, the RU comprising a plurality of antenna ports; a fronthaul interface between the RU and the BBU; the DU and RU being configured to agree on a Physical Random Access Channel (PRACH message; wherein the DU and RU agree to send a C-Plane message for only a first PRACH message, and the RU is configured to send PRACH messaging on receipt of the C-Plane message.

The PRACH message from the RU can comprise sequence IDs for the U-Plane. The PRACH message from the RU can comprise Physical Resource Block (PRB) ranges. The RU is configured to transmit alternating PRB block ranges following the C-Plane message. The RU can be configured to transmit alternating type identifiers following the C-Plane message. The RU can be configured to transmit alternating PRB block ranges following the C-Plane message. The Message content for the C-Plane message can comprise fields including: a Message type, a Sequence ID for a sequence number of the C-plane message or the U-Plane message, a Data Direction, a Frame Id, a Subframe Id, and a Slot Id.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified. For a better understanding, reference will be made to the following Detailed Description, which is to be read in association with the accompanying drawings.

FIG. 1 illustrates an example of a CRAN system architecture.

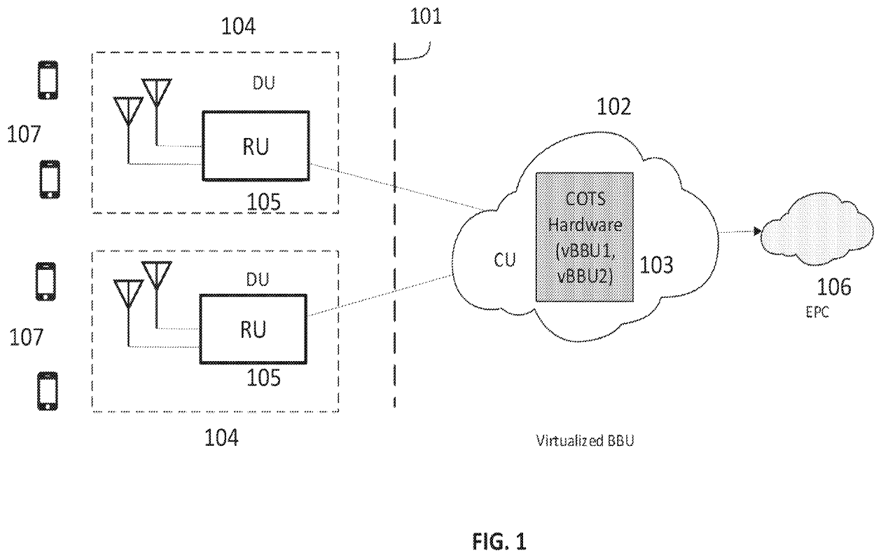

FIG. 2 shows a message content.

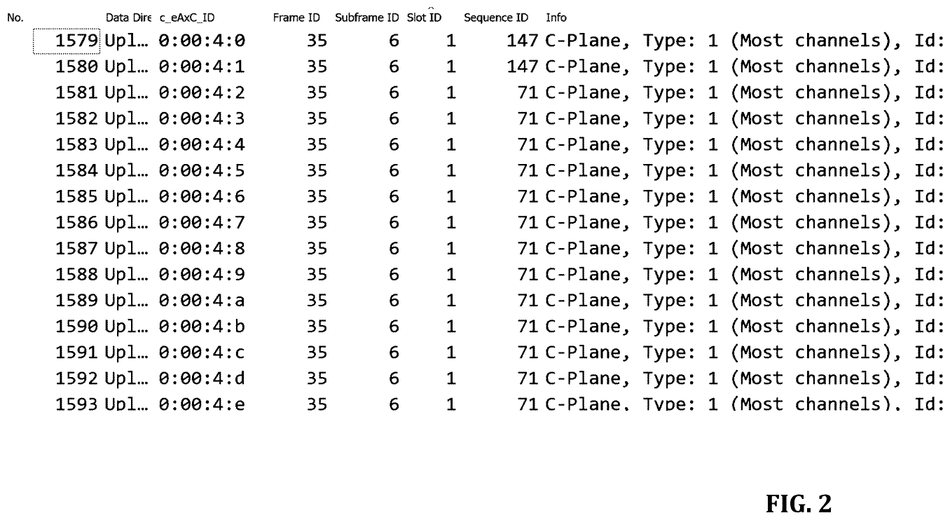

FIG. 3 shows an example of an O-RAN architecture.

FIG. 4 shows a message content.

FIG. 5 shows a message content

### DETAILED DESCRIPTION OF THE EMBODIMENTS

Reference is made to Third Generation Partnership Project (3GPP) system, the O-RAN Fronthaul Working Group, and the xRAN Fronthaul Working Group in accordance with embodiments of the present disclosure. The present application employs abbreviations, terms and technology defined in accord with Third Generation Partnership Project (3GPP) technology standards, O-RAN Fronthaul Working Group technology standards, and xRAN Fronthaul Working Group technology standards, including the following standards and definitions. Reference is also made to CPRI, the Industry Initiative for a Common Public Radio Interface, in accordance with embodiments of the present disclosure.

The 3GPP, O-RAN Fronthaul Working Group, CPRI, and xRAN Fronthaul Working Group technical specifications (TS) and technical reports (TR) referenced herein are incorporated by reference in their entirety herein and define the related terms and architecture reference models that follow.

### REFERENCES

[1] TR 38.801 V14.0.0 (2017-03)
[2] 3GPP TS 38.401 version 17.4.0 (2023-04-03)
[3] O-RAN-WG4.CUS.0-v7.02 (2022-09)

### Acronyms

3GPP: Third generation partnership project
BBU: Baseband unit
BS: Base Station
COTS: Commercial off-the-shelf
C-plane: Control plane
C-RAN: cloud radio access network
CU: Central unit
CPRI: Common Public Radio Interface
DL: downlink
DU: Distribution unit
eNB: Evolved Node B
gNB: g NodeB (applies to NR)
NR: New Radio
MAC: Medium Access Control
MIMO: multiple input, multiple output
O-DU: O-RAN Distributed Unit
O-RU: O-RAN Radio Unit
O-RAN: Open RAN
OPEX: Operating Expense
PRB: Physical Resource Block
PRACH: Physical Random Access Channel
RA: Random Access
RAN Intelligent Controller (RIC)
RA-RNTI: Random Access-Radio Network Temporary Identity
RACH: Random Access Channel
RAP: Random Access Preamble
RAPID: Random Access Preamble Identifier
RAR: Random Access Response
RLC: Radio Link Control
RRU: Remote radio unit
RO: RACH Occasion
RU: Radio Unit
SRS: Sounding reference signal
U-plane: User plane
UE: user equipment
UL: uplink

### Definitions

Channel: the contiguous frequency range between lower and upper frequency limits.
C-plane: Control Plane: refers specifically to real-time control between O-DU and O-RU, and should not be confused with the UE's control plane.
DL: DownLink: data flow towards the radiating antenna (generally on the LLS interface).
LLS: Lower Layer Split: logical interface between O-DU and O-RU when using a lower layer (intra-PHY based) functional split.
O-CU: O-RAN Control Unit-a logical node hosting PDCP, RRC, SDAP and other control functions.
O-DU: O-RAN Distributed Unit: a logical node hosting RLC/MAC/High-PHY layers based on a lower layer functional split.
O-RU: O-RAN Radio Unit: a logical node hosting Low-PHY layer and RF processing based on a lower layer functional split. This is similar to 3GPP's “TRP” or “RRH” but more specific in including the Low-PHY layer (FFT/IFFT, PRACH extraction).
OTA: Over the Air
U-Plane: User Plane: refers to IQ sample data transferred between O-DU and O-RU
UL: UpLink: data flow away from the radiating antenna (generally on the LLS interface)

The present disclosure provides embodiments of systems, devices and methods for LTE operation for Cloud RANs.

### O-RAN Architecture

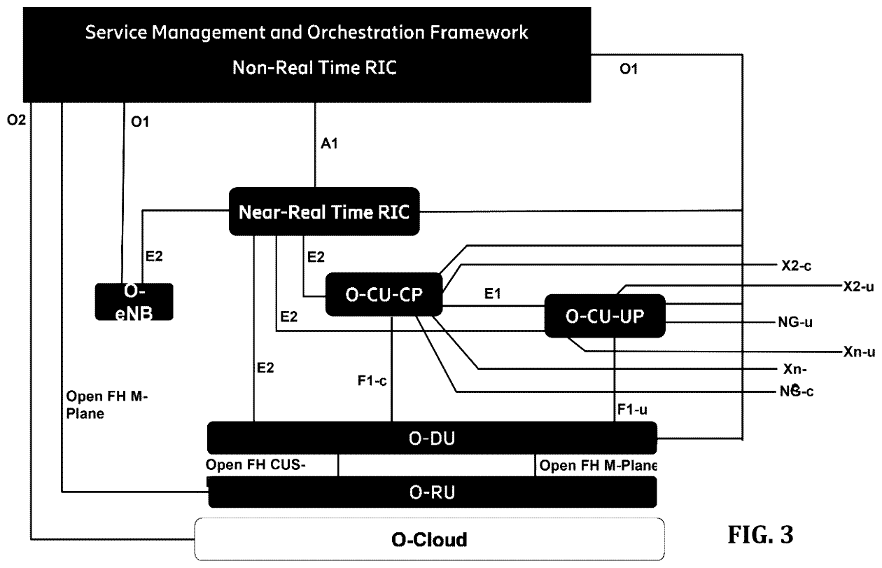

O-RAN, which is based on disaggregated components and connected through open and standardized interfaces is based on 3GPP NG-RAN. An overview of O-RAN with disaggregated RAN (CU, DU, and RU), near-real-time RAN Intelligent Controller (RIC) and non-real-time RIC is shown in the FIG. 3. Here, DU (Distributed Unit) and CU (Centralized Unit) are typically implemented using COTS (Commercial off-the-shelf) hardware.

An NG-RAN (NG-Radio Access Network) architecture is described in 3GPP TS 38.401. In the NG-RAN, an F1 is the interface between gNB-CU (gNB-Centralized Unit) and gNB-DU (gNB-Distributed Unit), NG is the interface between gNB-CU (or gNB) and 5GC (5G Core), E1 is the interface between CU-CP (CU-Control Plane) and CU-UP (CU-User Plane), and Xn is interface between gNBs. A gNB may consist of a gNB-CU-CP, multiple gNB-CU-UPs and multiple gNB-DUs. The gNB-CU-CP is connected to the gNB-DU through the F1-C interface and to the gNB-CU-UP through the E1 interface. The gNB-CU-UP is connected to the gNB-DU through the F1-U interface and to the gNB-CU-CP through the E1 interface. One gNB-DU is connected to only one gNB-CU-CP and one gNB-CU-UP is connected to only one gNB-CU-CP.

FIG. 3 shows and example of an O-RAN architecture. The CU and the DU are connected using an F1 interface (with F1-C for control plane and F1-U for user plane traffic) over a midhaul (MH) path. One DU could host multiple cells (for example, one DU could host 24 cells) and each cell may support many users. For example, one cell can support 600 RRC Connected users and out of these 600, there may be 200 Active users (i.e. users which have data to send at a given point of time).

A cell site can consist of multiple sectors and each sector may support multiple cells. For example one site could consist of three sectors and each sector could support 8 cells (with 8 cells in each sector on different frequency bands). One CU-CP can support multiple DUs and thus multiple cells. For example, a CU-CP can support 1000 cells and around 100,000 UEs. Each UE can support multiple DRBs and there can be multiple instances of CU-UP to serve these DRBs. For example, each UE could support 4 DRBs, and 400,000 DRBs (corresponding to 100,000 UEs) can be served by five CU-UP instances (and one CU-CP instance).

DU can be located in a private data center or it can be located at a cell-site. CU can also be located in a private data center or even hosted on a public cloud system. DU and CU can be tens of kilometers away. CU can communicate with 5G core system which could also be hosted in the same public cloud system (or could be hosted by a different cloud provider). RU (Radio Unit) is located at cell-site and communicated with DU via a fronthaul (FH) interface.

The E2 nodes (CU and DU) are connected to the near-real-time RIC using an E2 interface. The E2 interface is used to send data (e.g., user, cell, slice KPMs) from the RAN, and deploy control actions and policies to the RAN at near-real-time RIC. The application or service at the near-real-time RIC that deploys the control actions and policies to the RAN are called xApps. The near-real-time RIC is connected to the non-real-time RIC using an A1 interface. O-RAN, which is based on disaggregated components and connected through open and standardized interfaces is based on 3GPP LTE and NR RAN. An overview of O-RAN showing disaggregated RAN (CU, DU, and RU), near-real-time RIC and non-real-time RIC is shown in FIG. 3.

### Aspects of the Disclosure can be Summarized as Follows:

O-RAN compliant distributed units (O-DUs) and O-RAN compliant radio units (O-RUs) are capable of beamforming/MIMO. For an RU integration, the DU and RU needs to agree with the eAxC id offset of a sounding reference signal (SRS) (e.g.: 64 for a 64TRX). Then both DU and RU can know the eAxC id for the SRS ANT (e.g. the eAxC id>=64).

The O-RAN CUS specification includes an “ExtType=7: eAxC Mask Section Extension,” however as of the present disclosure there is no RU implementation due to the unduly burdensome computational costs on the DU and RU. [3] The O-RAN Fronthaul Working Group Control, User and Synchronization Plane Specification v 07.02 O-AN-WG4.CUS.0-v7.02 (2022 September).

In an implementation, the DU and RU agree to send a C-Plane message for only the first ANT's C-Plane. As the DU needs the data for each ANT, after the RU receives the 1st ANT's C-Plane message, the RU can start sending all ANT's data.

TABLE 2
Sequence ID Info

| | | | Frame | Subframe | Slot | Sequence | |
|---|---|---|---|---|---|---|---|
| No. | Data Dire | c_eAxC_ID | ID | ID | ID | ID | Info |
| 1579 | Upl . . . | 0:00:4:0 | 35 | 6 | 1 | 147 | C-Plane, Type: 1 (Most channels), Id: |
| 1680 | Upl . . . | 0:00:4:0 | 35 | 6 | 1 | 246 | U-Plane, Id: 0 (PRB: 0-135) |
| 1681 | Upl . . . | 0:00:4:0 | 35 | 6 | 1 | 247 | U-Plane, Id: 1 (PRB: 136-271) |
| 1682 | Upl . . . | 0:00:4:1 | 35 | 6 | 1 | 246 | U-Plane, Id: 0 (PRB: 0-135) |
| 1683 | Upl . . . | 0:00:4:1 | 35 | 6 | 1 | 247 | U-Plane, Id: 1 (PRB: 136-271) |
| 1696 | Upl . . . | 0:00:4:2 | 35 | 6 | 1 | 246 | U-Plane, Id: 0 (PRB: 0-135) |
| 1697 | Upl . . . | 0:00:4:2 | 35 | 6 | 1 | 247 | U-Plane, Id: 1 (PRB: 136-271) |
| 1698 | Upl . . . | 0:00:4:3 | 35 | 6 | 1 | 246 | U-Plane, Id: 0 (PRB: 0-135) |
| 1699 | Upl . . . | 0:00:4:3 | 35 | 6 | 1 | 247 | U-Plane, Id: 1 (PRB: 136-271) |
| 1712 | Upl . . . | 0:00:4:4 | 35 | 6 | 1 | 246 | U-Plane, Id: 0 (PRB: 0-135) |
| 1713 | Upl . . . | 0:00:4:4 | 35 | 6 | 1 | 247 | U-Plane, Id: 1 (PRB: 136-271) |
| 1714 | Upl . . . | 0:00:4:5 | 35 | 6 | 1 | 246 | U-Plane, Id: 0 (PRB: 0-135) |
| 1715 | Upl . . . | 0:00:4:5 | 35 | 6 | 1 | 247 | U-Plane, Id: 1 (PRB: 136-271) |
| 1728 | Upl . . . | 0:00:4:6 | 35 | 6 | 1 | 246 | U-Plane, Id: 0 (PRB: 0-135) |
| 1730 | Upl . . . | 0:00:4:6 | 35 | 6 | 1 | 247 | U-Plane, Id: 1 (PRB: 136-271) |

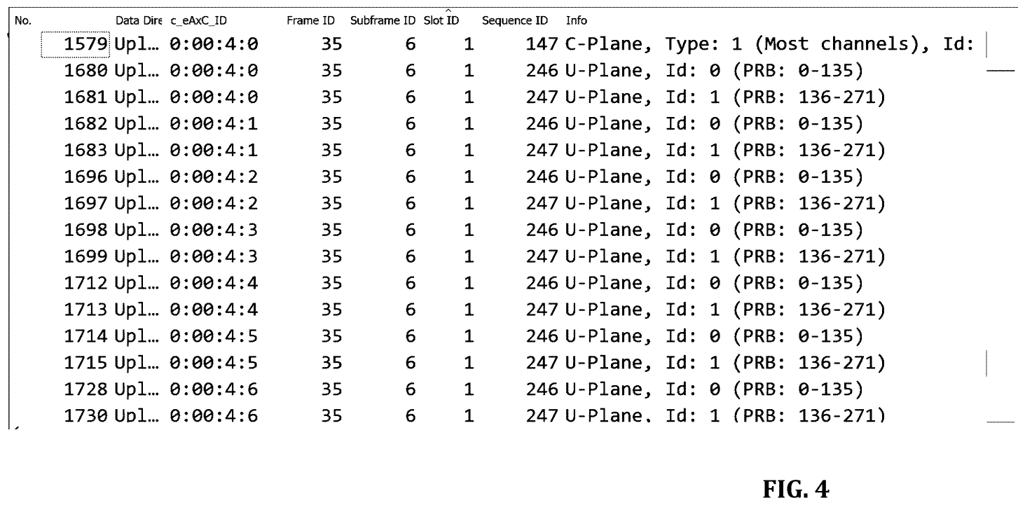

As shown in FIG. 4 and Table 2, message content for all ANTs can be sent using only 1 C-Plane message as a first C-Plane message. After the RU receives the first ANT's C-Plane information, the RU can start sending all ANT's data. After the C-Plane message, the following messages include the Sequence IDs for the U-Plane, alternating 0 and 1 Type IDs, and corresponding alternating PRB block ranges PRB: 0-135 and PRB: 136-271. As such, there is no CUS plane effort, which saves the processing costs on the DU and RU.

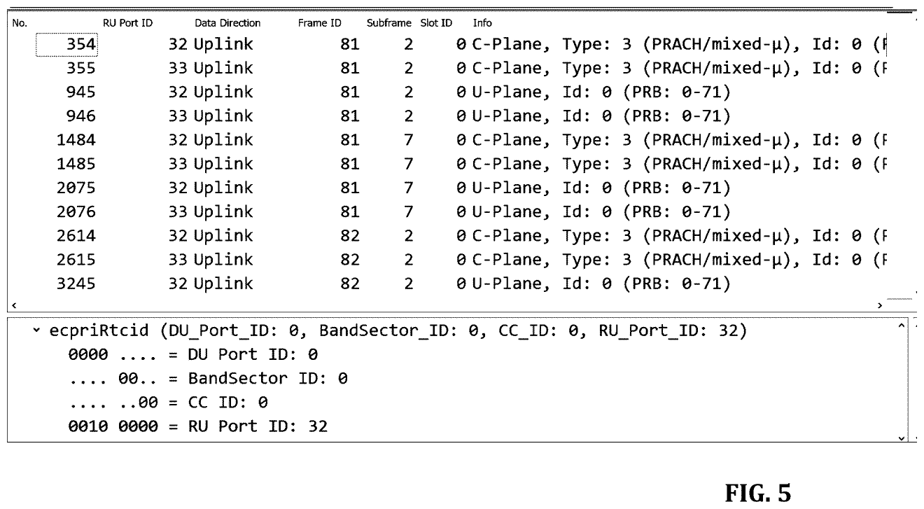

In another implementation, this method can be applied to PRACH messaging as well. PRACH can contain a 2/4/8/16 layer. In implementations, as shown for example in FIG. 5 and Table 3, the DU can be configured to send only a first layer's C-plane message as described herein.

TABLE 3

| | RU | Data | Frame | | Slot | |
|---|---|---|---|---|---|---|
| No. | Port ID | Direction | ID | Subframe | ID | Info |
| 354 | 32 | Uplink | 81 | 2 | 0 | C-Plane, Type: 3 (PRACH/mixed-μ), Id: 0 ( [symbol] |
| 355 | 33 | Uplink | 81 | 2 | 0 | C-Plane, Type: 3 (PRACH/mixed-μ), Id: 0 ( [symbol] |
| 945 | 32 | Uplink | 81 | 2 | 0 | U-Plane, Id: 0 (PRB: 0-71) |
| 946 | 33 | Uplink | 81 | 2 | 0 | U-Plane, Id: 0 (PRB: 0-71) |
| 1484 | 32 | Uplink | 81 | 7 | 0 | C-Plane, Type: 3 (PRACH/mixed-μ), Id: 0 ( [symbol] |
| 1485 | 33 | Uplink | 81 | 7 | 0 | C-Plane, Type: 3 (PRACH/mixed-μ), Id: 0 ( [symbol] |
| 2075 | 32 | Uplink | 81 | 7 | 0 | U-Plane, Id: 0 (PRB: 0-71) |
| 2076 | 33 | Uplink | 81 | 7 | 0 | U-Plane, Id: 0 (PRB: 0-71) |
| 2614 | 32 | Uplink | 82 | 2 | 0 | C-Plane, Type: 3 (PRACH/mixed-μ), Id: 0 ( [symbol] |
| 2615 | 33 | Uplink | 82 | 2 | 0 | C-Plane, Type: 3 (PRACH/mixed-μ), Id: 0 ( [symbol] |
| 3245 | 32 | Uplink | 82 | 2 | 0 | U-Plane, Id: 0 (PRB: 0-71) |

```
ecpriRtcid (DU_Port_ID: 0, BandSector_ID: 0, CC_ID: 0, RU_Port_ID: 32)
  0000 .... = DU Port ID: 0
  .... 00.. = BandSector ID: 0
  .... ..00 = CC ID: 0
  0010 0000 = RU Port ID: 32 [symbol]
indicates data missing or illegible when filed
```

In Tables 1-3, the fields are as follows:
Message type=1 (Most channels).
Sequence ID identifies the sequence number of the C-plane or U-Plane message.
DataDirection: 0=UL, 1=DL.
FrameId points to a specific 10 ms frame.
SubframeId points to a specific 1 ms subframe within a frame.
slotId points to a specific slot within a frame.

It will be understood that implementations and embodiments can be implemented by computer program instructions. These program instructions can be provided to a processor to produce a machine, such that the instructions, which execute on the processor, create means for implementing the actions specified herein. The computer program instructions can be executed by a processor to cause a series of operational steps to be performed by the processor to produce a computer-implemented process such that the instructions, which execute on the processor to provide steps for implementing the actions specified. Moreover, some of the steps can also be performed across more than one processor, such as might arise in a multi-processor computer system or even a group of multiple computer systems. In addition, one or more blocks or combinations of blocks in the flowchart illustration can also be performed concurrently with other blocks or combinations of blocks, or even in a different sequence than illustrated without departing from the scope or spirit of the invention.

1. A cloud radio access network (CRAN) system, comprising:
a baseband unit (BBU) having a centralized unit (CU) and a distributed unit (DU); and
a radio unit (RU) remote from the BBU and comprising a plurality of antenna ports;
a fronthaul interface between the RU and the BBU;
the DU and RU being configured to agree on an antenna offset for a sounding reference signal (SRS);
wherein the DU and RU agree to send a C-Plane message for only a first antenna of the plurality of RU antenna ports, and
the RU is configured to send antenna data for the plurality RU antenna ports on receipt of the C-Plane message.

2. The CRAN system of claim 1, wherein the antenna data from the RU comprises sequence IDs for the U-Plane.

3. The CRAN system of claim 1, wherein the antenna data from the RU comprises Physical Resource Block (PRB) ranges.

4. The CRAN system of claim 3, wherein the RU is configured to transmit alternating PRB block ranges following the C-Plane message.

5. The CRAN system of claim 1, wherein the RU is configured to transmit alternating type identifiers following the C-Plane message.

6. The CRAN system of claim 5, wherein the RU is configured to transmit alternating PRB block ranges following the C-Plane message.

7. The CRAN system of claim 1, wherein the C-Plane message includes an extended Antenna-Carrier (eAxC) identifier.

8. The CRAN system of claim 2, wherein message content for the C-Plane message comprises fields including: a Message type, a Sequence ID for a sequence number of the C-plane message or the U-Plane message, a Data Direction, a Frame Id, a Subframe Id, and a Slot Id.

9. A cloud radio access network (CRAN) system, comprising:
a baseband unit (BBU) having a centralized unit (CU) and a distributed unit (DU); and
a radio unit (RU) remote from the BBU, the RU comprising a plurality of antenna ports;
a fronthaul interface between the RU and the BBU;
the DU and RU being configured to agree on a Physical Random Access Channel (PRACH) message;
wherein the DU and RU agree to send a C-Plane message for only a first PRACH message,
the RU being configured to send PRACH messaging on receipt of the C-Plane message.

10. The CRAN system of claim 9, wherein the PRACH messaging from the RU comprises sequence IDs for the U-Plane.

11. The CRAN system of claim 9, wherein the PRACH messaging from the RU comprises Physical Resource Block (PRB) ranges.

12. The CRAN system of claim 11, wherein the RU is configured to transmit alternating PRB block ranges following the C-Plane message.

13. The CRAN system of claim 9, wherein the RU is configured to transmit alternating type identifiers following the C-Plane message.

14. The CRAN system of claim 13, wherein the RU is configured to transmit alternating PRB block ranges following the C-Plane message.

15. The CRAN system of claim 10, wherein message content for the C-Plane message comprises fields including: a Message type, a Sequence ID for a sequence number of the C-plane message or the U-Plane message, a Data Direction, a Frame Id, a Subframe Id, and a Slot Id.
